(19) United States
(12) Patent Application Publication
(10) Pub. No.: US 2025/0300789 A1
(43) Pub. Date: Sep. 25, 2025

(54) Communications Systems with Trigger Frame Feedback

(71) Applicant: Apple Inc., Cupertino, CA (US)

(72) Inventors: Abdel Karim Ajami, San Jose, CA (US); Jinjing Jiang, Campbell, CA (US); Brajesh K. Dave, Cupertino, CA (US); Anuj Batra, Redwood City, CA (US); Yong Liu, Campbell, CA (US); Oren Shani, Saratoga, CA (US)

(21) Appl. No.: 19/063,074

(22) Filed: Feb. 25, 2025

Related U.S. Application Data
(60) Provisional application No. 63/568,521, filed on Mar. 22, 2024.

(51) Int. Cl. H04L 5/00

(52) U.S. Cl. CPC H04L 5/0055

(57) ABSTRACT

A communication system is provided in which access points (APs) communicate with stations (STAs). An AP may communicate with a STA according to a communications protocol that implements trigger-based uplink (UL) transmission such as an IEEE 802.11 protocol. The AP may transmit trigger frames to the STA that trigger UL transmissions by the STA under the protocol. The STA may generate trigger frame feedback based at least in part on downlink signals transmitted by the AP. The STA may transmit the trigger frame feedback to the AP. The AP may adjust scheduling of the trigger frames based on the trigger frame feedback. This may include adjusting how often the AP transmits the trigger frames and/or adjusting a resource allocation of the trigger frames. The trigger frame feedback may serve to maximize the efficiency with which the STA and the AP utilize the propagation medium between the STA and the AP.

This application claims the benefit of U.S. Provisional Patent Application No. 63/568,521, filed Mar. 22, 2024, which is hereby incorporated by reference herein in its entirety.

### FIELD

This disclosure relates generally to wireless communications, including wireless communications by electronic devices.

### BACKGROUND

Communications systems and methods are used to convey wireless data between nodes of a communications network. The nodes can include user equipment devices, wireless access points, wireless base stations, or other electronic devices.

It can be challenging to ensure that communications systems exhibit sufficient levels of performance. If care is not taken, nodes of a communications network can exhibit inefficient utilization of the wireless propagation medium, leading to unnecessary power and resource consumption at one or more of the nodes.

### SUMMARY

A communication system is provided in which access points (APs) communicate with stations (STAs). An AP may communicate with a STA according to a communications protocol that implements trigger-based uplink (UL) transmission such as an IEEE 802.11 protocol. The AP may transmit trigger frames to the STA that trigger UL transmissions by the STA under the protocol.

The STA may generate trigger frame feedback based at least in part on downlink signals transmitted by the AP and/or UL transmissions performed by the STA in response to one or more of the trigger frames. The STA may transmit the trigger frame feedback to the AP. The AP may adjust scheduling of the trigger frames based on the trigger frame feedback. This may include adjusting how often the AP transmits the trigger frames and/or adjusting a resource allocation of the trigger frames. The trigger frame feedback may serve to maximize the efficiency with which the STA and the AP utilize the wireless propagation medium between the STA and the AP.

An aspect of the disclosure provides a method of operating a station (STA) to communicate with an access point (AP) according to a communications protocol that implements trigger-based uplink (UL) transmission. The method can include receiving, using one or more antennas, downlink (DL) signals transmitted by the AP according to the communications protocol. The method can include transmitting, using the one or more antennas, trigger frame feedback to the AP, the trigger frame feedback being based at least in part on the DL signals. The method can include receiving, using the one or more antennas, trigger frames that are transmitted by the AP based on the trigger frame feedback. The method can include transmitting, using the one or more antennas, UL frames responsive to the trigger frames transmitted by the AP.

An aspect of the disclosure provides an electronic device configured to communicate with an access point (AP) according to a communications protocol that implements trigger-based uplink (UL) transmission. The electronic device can include one or more antennas configured to receive trigger frames transmitted by the AP. The electronic device can include a transmitter communicatively coupled to the one or more antennas. The transmitter can be configured to transmit, using the one or more antennas, a request to the AP to adjust a schedule with which the AP transmits the trigger frames. The transmitter can be configured to transmit, using the one or more antennas, UL frames to the AP responsive to the trigger frames transmitted by the AP.

An aspect of the disclosure provides a method of operating an access point (AP) to communicate with a station (STA) according to a communications protocol that implements trigger-based uplink (UL) transmission. The method can include periodically transmitting trigger frames to the STA, wherein the trigger frames trigger UL transmissions by the STA. The method can include receiving trigger frame feedback from the STA. The method can include adjusting transmission of the trigger frames based on the trigger frame feedback. The method can include receiving, from the STA, UL frames transmitted by the STA in response to the trigger frames.

### BRIEF DESCRIPTION OF THE DRAWINGS

FIG. 1 is a diagram of an illustrative wireless communications system in with some embodiments.

FIG. 2 is a schematic diagram of an illustrative wireless station (STA) in accordance with some embodiments.

FIG. 3 is a schematic diagram of an illustrative wireless access point (AP) in accordance with some embodiments.

FIG. 4 is a timing diagram showing how an AP may trigger uplink transmissions by a STA in accordance with some embodiments.

FIG. 5 is a flow chart of illustrative operations involved in using a STA to transmit feedback that adjusts subsequent trigger frame transmissions by an AP in accordance with some embodiments.

FIG. 6 is a diagram of illustrative feedback that may be transmitted by a STA to adjust subsequent trigger frame transmissions by an AP in accordance with some embodiments.

FIG. 7 is a timing diagram illustrating different containers that may be utilized by a STA for transmitting feedback that adjusts subsequent trigger frame transmissions by an AP in accordance with some embodiments.

FIG. 8 is a plot of padding percentage as a function of time showing how communications efficiency can be maximized by adjusting trigger frame transmission by an AP based on feedback from a STA in accordance with some embodiments.

FIG. 9 is a diagram of an illustrative quality of service (QOS) characteristic element that may be transmitted by a STA to an AP in accordance with some embodiments.

FIGS. 10A-10B is a diagram of an illustrative basic trigger frame that may be transmitted by an AP to trigger uplink transmission by a STA in accordance with some embodiments.

FIGS. 11A-11B is a diagram of an illustrative MU RTS TXS trigger frame that may be transmitted by an AP to trigger uplink transmission by a STA in accordance with some embodiments.

FIG. 12 is a diagram of an illustrative uplink frame that may be transmitted by a STA to an AP in accordance with some embodiments.

### DETAILED DESCRIPTION

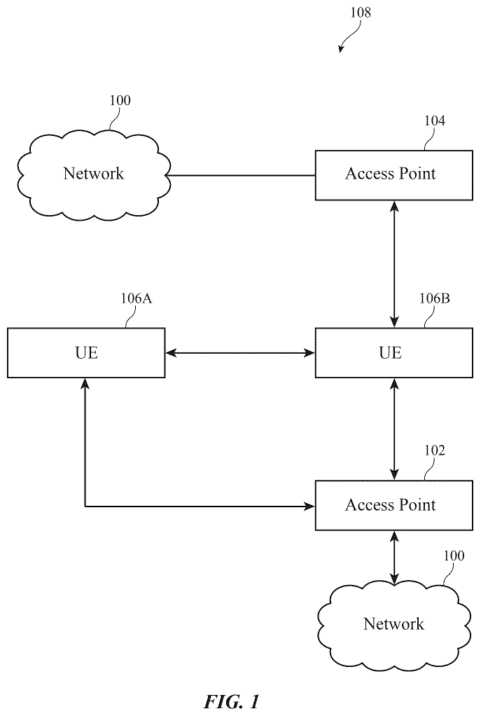

FIG. 1 illustrates an example of a wireless communication system 108 (sometimes also referred to herein as wireless communications network 108, communications network 108, network 108, or system 108). It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown in FIG. 1, the exemplary wireless communication system 108 includes an access point (AP) 104, which communicates over a transmission medium with one or more wireless devices 106 (e.g., a first wireless device 106A, a second wireless device 106B, etc.). Wireless devices 106A and 106B may be user devices (e.g., user equipment (UE) devices), such as stations (STAs), non-AP STAs, or wireless local area network (WLAN) devices. Wireless devices 106 are sometimes referred to herein as STAs 106 or clients 106.

STA 106 may be a device with wireless network connectivity such as a mobile (e.g., cellular) telephone, a hand-held device, a wearable device (e.g., a wristwatch device, pendant device, ring device, head-mounted device such as a virtual, mixed, and/or augmented reality headset, goggles, helmet, or glasses, etc.), a computer (e.g., a desktop computer, laptop computer, a computer monitor containing an embedded computer, etc.), a tablet computer, a media player, headphones, one or two wireless earbuds, a television, a gaming device or console, a navigation device, an embedded system such as a system in which electronic equipment with a display is mounted in a kiosk or automobile, a wireless internet-connected voice-controlled speaker, a home entertainment device, a remote control device, a gaming controller, a user input device, peripheral, or accessory, an electronic stylus or pen, an unmanned aerial vehicle (UAV), an unmanned aerial controller (UAC), an automobile, computing equipment integrated into a vehicle or kiosk, equipment that implements the functionality of two or more of these devices, or virtually any type of wireless device.

STA 106 may include a processor (processing element) that is configured to execute program instructions stored in memory. STA 106 may perform any of the method embodiments described herein by executing such stored instructions. Alternatively, or in addition, STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

Wireless communications system 108 may include one or more wireless access points (APs) such as AP 102. AP 102 may be a stand-alone AP or an enterprise AP and may include hardware that enables wireless communication with STAs 106 such as STA 106A and STA 106B. AP 102 may also be equipped to communicate with a network 100 (e.g., a WLAN, an enterprise network, and/or another communication network connected to the Internet, among various possibilities). Thus, AP 102 may facilitate communication among STAs 106 and/or between STAs 106 and network 100. AP 102 can be configured to provide communications over one or more wireless technologies, such as any of 802.11 a, b, g, n, ac, ad, ax, ay, be, bn, and/or other 802.11 versions, or a cellular protocol, such as 5G or LTE, including in an unlicensed band (LAA).

Network 100 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of network 100 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of network 100 may include network switches, network routers, optical add-drop multiplexers, other multiplexers, repeaters, modems, portals, gateways, servers, network cards (line cards), wireless access points, wireless base stations, and/or any other desired network components. The network nodes in network 100 may include physical components such as electronic devices, servers, computers, network racks, line cards, user equipment, etc., and/or may include virtual components that are logically defined in software and that are distributed across (over) two or more underlying physical devices (e.g., in a cloud network configuration).

The communication area (or coverage area) of AP 102 (or AP 104) may be referred to as a basic service area (BSA) or cell. AP 102 (or AP 104) and STAs 106 may be configured to communicate over the transmission medium using any of various radio access technologies (RATs) or wireless communication technologies, such as Wi-Fi, LTE, LTE-Advanced (LTE-A), 5G NR, ultra-wideband (UWB), etc. A given RAT may, for example, specify the physical methodology used in implementing a corresponding communications protocol (e.g., a WLAN protocol, a wireless personal area network (WPAN) protocol, a cellular telephone protocol such as a 3G protocol, a 4G (LTE) protocol, a 5G (NR) protocol, etc., a UWB protocol, a satellite communications protocol, a satellite navigation protocol, a device-to-device (D2D) protocol, etc.).

AP 102, AP 104, and other similar access points (not shown) operating according to one or more wireless communication technologies may thus be provided as a network, which may provide continuous or nearly continuous overlapping service to STAs 106A and 106B and similar devices over a geographic area (e.g., via one or more communication technologies). A STA may roam from one AP to another AP directly or may transition between APs and cellular network cells, for example.

Note that at least in some instances STA 106 may be capable of communicating using any of multiple wireless communication technologies. For example, STA 106 might be configured to communicate using one or more of Wi-Fi, LTE, LTE-A, 5G NR, Bluetooth, UWB, one or more satellite systems, etc. Other combinations of wireless communication technologies (including more than two wireless communication technologies) are also possible. Likewise, in some instances STA 106 can be configured to communicate using only a single wireless communication technology.

As shown in FIG. 1, the exemplary wireless communication system 108 can also include an AP 104, which communicates over a transmission medium with the wireless device 106B. AP 104 also provides communicative connectivity to network 100. Thus, according to some embodiments, wireless devices may be able to connect to either or both of AP 102 (or a cellular base station (BS)) and AP 104 (or another access point) to access the network 100. For example, a STA may roam from AP 102 to AP 104 based on one or more factors, such as coverage, interference, and capabilities. Note that it may also be possible for AP 104 to provide access to a different network (e.g., an enterprise Wi-Fi network, a home Wi-Fi network, etc.) than the network to which the AP 102 provides access.

In some implementations, STAs 106 (e.g., STAs 106A and 106B) may include handheld devices such as smart phones or tablets, wearable devices such as smart watches or smart glasses, and/or may include any of various types of devices with wireless communication capability. For example, one or more of the STAs 106A and/or 106B may be a wireless device intended for stationary or nomadic deployment such as an appliance, measurement device, control device, etc.

STA 106B may also be configured to communicate with STA 106A. For example, STA 106A and STA 106B may be capable of performing direct device-to-device (D2D) communication. In some embodiments, such direct communication between STAs may also or alternatively be referred to as peer-to-peer (P2P) communication. The direct communication may be supported by AP 102 (e.g., AP 102 may facilitate discovery, among various possible forms of assistance), or may be performed in a manner unsupported by the AP 102. Such P2P communication may be performed using 3GPP-based D2D communication techniques, Wi-Fi-based P2P communication techniques, UWB, Bluetooth (BT), and/or any of various other direct communication techniques, according to various embodiments.

STA 106 may include one or more devices or integrated circuits for facilitating wireless communication, potentially including a WLAN (e.g., Wi-Fi) modem, a cellular modem, and/or one or more other wireless modems. The wireless modem(s) may include one or more processors (processor elements) and various hardware components as described herein. STA 106 may perform any of (or any portion of) the method embodiments described herein by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The wireless modem(s) described herein may be used in a STA as defined herein, a wireless device as defined herein, or a communication device as defined herein. The wireless modem described herein may also be used in an AP, a base station, a pico cell, a femto cell, or other similar network side device.

STA 106 may include one or more antennas for communicating using one or more wireless communication protocols or radio access technologies. In some embodiments, STA 106 can be configured to communicate using a single shared radio. The shared radio may couple to a single antenna, or may couple to multiple antennas (e.g., for multiple-input-and-multiple-output (MIMO)) for performing wireless communications. Alternatively, STA 106 may include two or more radios, each of which may be configured to communicate via a respective wireless link. Other configurations are also possible.

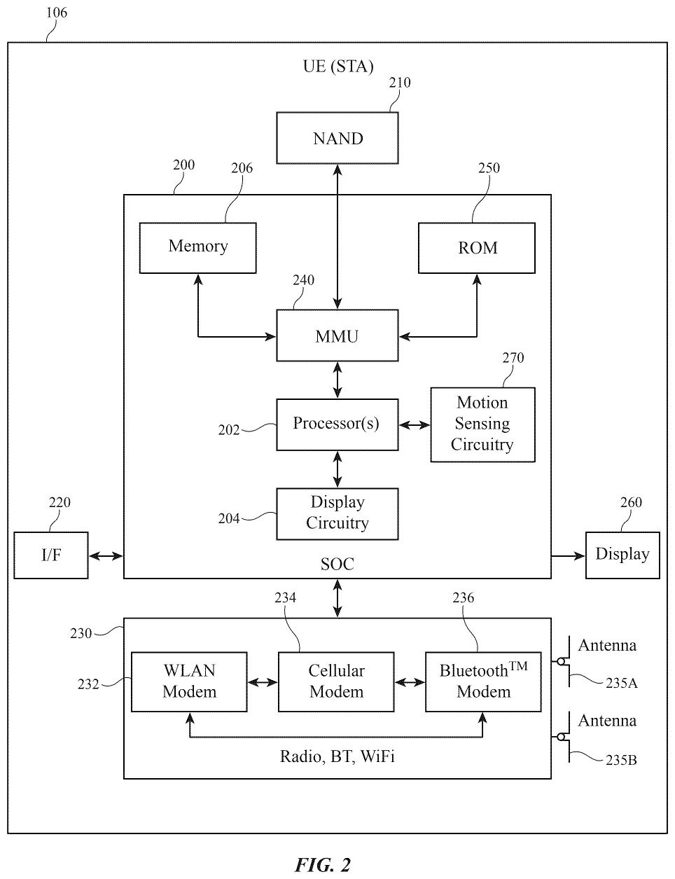

FIG. 2 is one possible block diagram of a STA device such as STA 106. STA 106 is sometimes also referred to herein as UE 106, UE device 106, device 106, or client 106. STA 106 also may be referred to herein as non-AP STA 106, non-AP device 106, or non-AP client 106. As shown in FIG. 2, STA 106 may include wireless circuitry such as wireless communication circuitry 230, a subsystem such as system on chip (SOC) 200, a display such as display 260, and one or more interfaces such as connector interface (I/F) 220.

SOC 200 may include one or more portions configured for various purposes. For example, as shown in FIG. 2, SOC 200 may include one or more processors 202 and display circuitry 204. Processor(s) 202 may execute program instructions for STA 106. Display circuitry 204 may perform graphics processing and may provide display signals to display 260. Display 260 may be a touch-sensitive display, a force sensitive display, or a display without touch or force sensitivity. Display 260 may include one or more arrays of display pixels that emit light containing images, for example.

SOC 200 may also include sensor circuitry such as motion sensing circuitry 270. Motion sensing circuitry 270 may detect motion of the STA 106 using, for example, a gyroscope, accelerometer, inertial measurement unit (IMU), compass, and/or any of various other motion sensing components. Processor(s) 202 may also be coupled to memory management unit (MMU) 240, which may be configured to receive addresses from processor(s) 202 and may translate those addresses to locations in memory or other storage circuitry (e.g., memory 206, read only memory (ROM) 250, flash (NAND) memory 210, etc.). MMU 240 may be configured to perform memory protection and page table translation or set up. In some embodiments, MMU 240 may be included as a portion of processor(s) 202.

SOC 200 may be coupled to various other circuits in STA 106. For example, SOC 200 may be coupled to various types of memory (e.g., flash memory 210), connector interface 220 (e.g., for coupling to a computer system, dock, charging station, etc.), display 260, and wireless communication circuitry 230 (e.g., for performing wireless communications under LTE, LTE-A, 5G NR, Bluetooth, Wi-Fi, NFC, GPS, UWB, etc.).

STA 106 may include at least one antenna 235. If desired, STA 106 may include multiple antennas 235 such as at least a first antenna 235A and a second antenna 235B. STA 106 may use antennas 235 to perform wireless communication with access points, base stations, and/or other devices. For example, STA 106 may use antennas 235A and 235B to perform the wireless communication with APs 102 and/or 104 of FIG. 1. As noted above, STA 106 may, in some embodiments, be configured to communicate wirelessly using multiple wireless communication standards or radio access technologies (RATs).

Wireless communication circuitry 230 may include one or more modems such as WLAN (e.g., Wi-Fi) modem 232, cellular modem 234, and Bluetooth modem 236. If desired, wireless communication circuitry 230 may include additional modems for handling other RATs or wireless communications technologies. STA 106 may use WLAN modem 232 (sometimes also referred to herein as Wi-Fi modem 232) to perform Wi-Fi or other WLAN communications (e.g., on an 802.11 network) with one or more external devices (e.g., AP 104 and/or 102 of FIG. 1). STA 106 may use Bluetooth modem 236 to perform Bluetooth communications or other WPAN communications with one or more external devices (e.g., another STA 106). STA 106 may use cellular modem 234 to perform cellular communications with one or more wireless base stations according to one or more cellular communication technologies (e.g., in accordance with one or more 3GPP specifications).

As described herein, STA 106 may include hardware and software components for implementing embodiments of this disclosure. For example, one or more components of the wireless communication circuitry 230 (e.g., Wi-Fi modem 232, cellular modem 234, BT modem 236) of the STA 106 may be configured to implement part or all of the methods described herein, e.g., by one or more processors executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit). STA 106 may include support structures such as a housing. The housing may include conductive and/or dielectric housing walls, layers, and/or other structures.

If desired, STA 106 may include additional include input-output devices (not shown for the sake of clarity). The input-output devices may be used to allow data to be supplied to STA 106 and to allow data to be provided from STA 106 to external devices. The input-output devices may include user interface devices, data port devices (e.g., interface 220), touch sensors, displays (e.g., display 260), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to STA 106 using wired or wireless connections (e.g., some of the input-output devices may be peripherals that are coupled to a main processing unit or other portion of STA 106 via a wired or wireless link).

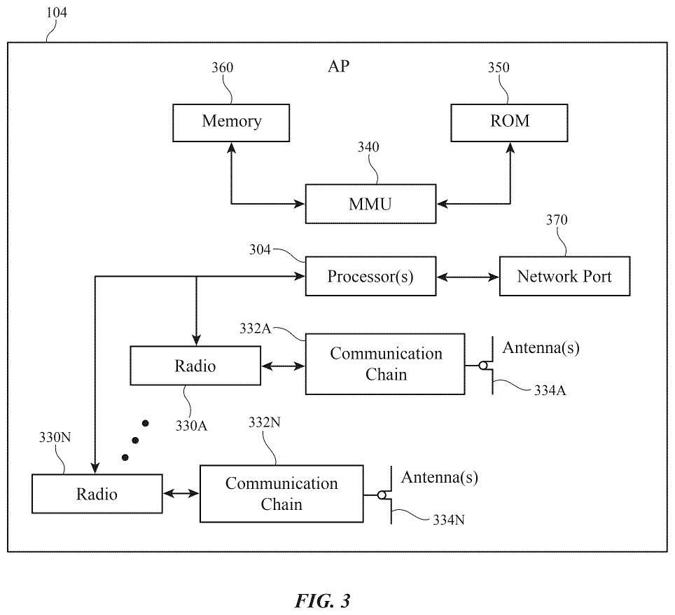

FIG. 3 is an example block diagram of an electronic device such as AP 104 (or equivalently AP 102 of FIG. 1). In some instances (e.g., in an 802.11 communication context), AP 104 may also be referred to as an AP STA. It is noted that the AP of FIG. 3 is merely one example of a possible access point. As shown, AP 104 may include one or more processors 304, which may execute program instructions for AP 104. Processor(s) 304 may also be coupled to MMU 340, which may be configured to receive addresses from processor(s) 304 and to translate those addresses to locations in memory (e.g., memory 360 and ROM 350) or to other storage circuitry, circuits, or devices.

AP 104 may include at least one network port 370. Network port 370 may be configured to couple to a network and to provide multiple devices, such as STAs 106, with access to the network (e.g., network 100 of FIG. 1). Network port 370 (or an additional network port) may also or alternatively be configured to couple to a cellular network (e.g., a core network (CN) of a cellular service provider). The core network may provide mobility related services and/or other services to a plurality of UE devices (e.g., STAs 106). In some cases, network port 370 may couple to a telephone network via the core network, and/or the core network may provide a telephone network (e.g., among other UE devices serviced by the cellular service provider).

AP 104 may include one or more radios 330A-330N, each of which may be coupled to a respective communication chain 332 and at least one antenna 334, and possibly multiple antennas (e.g., a first radio 330A coupled to antenna 334A via communication chain 332A, an Nth radio 330N coupled to antenna 334N via communication chain 332N, etc.). Radios 330 may be configured to operate as wireless transceivers that communicate with STAs 106 via communication chains 332 and antennas 334. Antenna(s) 334A-N communicate with their respective radios 330A-N via communication chains 332A-N. Communication chains 332 may be receive chains, may be transmit chains, or may include both transmit and receive chains. Radios 330A-N may be configured to communicate in accordance with various wireless communication standards including, but not limited to, LTE, LTE-A, 5G NR, 6G, UWB, WLAN (Wi-Fi), WPAN (BT), etc. If desired, AP 104 may be configured to operate on multiple wireless links using the one or more radios 330A-N, where each radio is used to operate on a respective wireless link.

AP 104 may be configured to communicate wirelessly using one or multiple wireless communication standards. In some instances, AP 104 may include multiple radios, which may enable the network entity to communicate according to multiple wireless communication technologies. For example, as one possibility, AP 104 may include an LTE or 5G NR radio for performing communication according to LTE or 5G as well as a Wi-Fi radio for performing communication according to Wi-Fi. In such a case, AP 104 may be capable of operating as both a cellular base station and a Wi-Fi access point. As another possibility, AP 104 may include a multi-mode radio, which is capable of performing communications according to any of multiple wireless communication technologies (e.g., NR and Wi-Fi, NR and LTE, etc.). As still another possibility, AP 104 may be configured to act exclusively as a Wi-Fi access point, e.g., without cellular communication capability.

As described further herein, AP 104 may include hardware and software components for implementing or supporting implementation of features described herein. Processor(s) 304 of AP 104 may be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, processor(s) 304 may be configured as a programmable hardware element, such as an FPGA (Field Programmable Gate Array) or ASIC (Application Specific Integrated Circuit), or a combination thereof. Alternatively (or in addition) the processor(s) 304 of AP 104, in conjunction with one or more of the other components 330, 332, 334, 340, 350, 360, 370 may be configured to implement, or support implementation of, part or all of the features described herein.

Radio(s) 330 on AP 104 may use antenna(s) 334 (FIG. 3) and wireless communication circuitry 230 on STA 106 may use antenna(s) 235 (FIG. 2) to transmit and/or receive radio-frequency signals within different frequency bands at radio frequencies (sometimes referred to herein as communications bands or simply as a “bands”). The frequency bands handled by AP 104 and STA 106 may include satellite communications bands (e.g., the C band, S band, L band, X band, W band, V band, K band, Ka band, Ku band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHz WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHZ, 5G New Radio Frequency Range 2 (FR2) bands between 20 and 60 GHZ, 6G bands, etc.), other centimeter or millimeter wave frequency bands between 10-300 GHz, near-field communications (NFC) frequency bands (e.g., at 13.56 MH2), satellite navigation frequency bands (e.g., a GPS band from 1565 to 1610 MHZ, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Antenna(s) 334 (FIG. 3) and antenna(s) 235 (FIG. 2) may be formed using any desired antenna structures. For example, the antennas may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas may include antenna resonating elements formed from conductive portions of a device housing (e.g., peripheral conductive housing structures extending around a periphery of a display on STA 106). Filter circuitry, switching circuitry, impedance matching circuitry, and/or other antenna tuning components may be adjusted to adjust the frequency response and wireless performance of the antennas over time. If desired, multiple antennas may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Wireless communication circuitry 230 may convey radio-frequency signals using antenna(s) 235 (FIG. 2). Radio(s) 330 may convey radio-frequency signals using antenna(s) 334 (FIG. 3). The term “convey radio-frequency signals” as used herein means the transmission and/or reception of the radio-frequency signals (e.g., for performing unidirectional and/or bidirectional wireless communications with external wireless communications equipment). The term “convey wireless data” as used herein means the transmission and/or reception of the wireless data (e.g., as carried by corresponding radio-frequency signals). Antennas may transmit radio-frequency signals by radiating the radio-frequency signals into free space (or to free space through intervening device structures such as a dielectric cover layer). Antennas may additionally or alternatively receive radio-frequency signals from free space (or through intervening devices structures such as a dielectric cover layer). The transmission and reception of radio-frequency signals by antennas each involve the excitation or resonance of antenna currents on an antenna resonating element in the antenna by the radio-frequency signals within the frequency band(s) of operation of the antenna.

Wireless communication circuitry 230 may be coupled to antenna(s) 235 (FIG. 2) over one or more radio-frequency transmission lines. Radio(s) 330 may be coupled to antenna(s) 334 (FIG. 3) over one or more radio-frequency transmission lines. Communication chain(s) 332 (FIG. 3) may be disposed on the radio-frequency transmission lines between antenna(s) 334 and radio(s) 330. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios or modems if desired. Radio-frequency front end (RFFE) modules may be interposed on one or more of the radio-frequency transmission lines if desired (e.g., within communication chain(s) 332 of FIG. 3 or within wireless communication circuitry 230 of FIG. 2). The radio-frequency front end modules may include substrates, integrated circuits, chips, or packages that are separate from the radios or modems and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Processor(s) 202 (FIG. 2) and processor(s) 304 (FIG. 3) may each include one or more processors such as microprocessors, microcontrollers, digital signal processors, host processors, baseband processing circuitry (e.g., one or more baseband processors or baseband processor integrated circuits), application specific integrated circuits (ASICs), FPGAs, central processing units (CPUs), graphics processing units (GPUs), etc. If desired, radio(s) 330 (FIG. 3) and/or wireless communication circuitry 230 may also include one or more processors. Baseband circuitry in STA 106 and/or AP 104 may, for example, access a communication protocol stack on corresponding storage circuitry (e.g., memory 206 of FIG. 2 or memory 360 of FIG. 3) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

AP 104 (or AP 102 of FIG. 1) may communicate with a STA 106 over a corresponding wireless communication link. Radio-frequency signals may be wirelessly conveyed between the radios and antennas on AP 104 and STA 106 to support the wireless communication link. The radio-frequency signals may include wireless data modulated onto one or more carriers of the radio-frequency signal (e.g., by a transmitter in radio 330 of AP 104 or a transmitter in a modem on wireless communication circuitry 230 of STA 106). The wireless data may be organized, modulated onto the radio-frequency signals, and demodulated from the radio-frequency signals (e.g., by a receiver in radio 330 of AP 104 or a receiver in a modem on wireless communication circuitry 230 of STA 106) according to a corresponding communications protocol or standard (e.g., an IEEE 802.11 protocol or standard). The radio-frequency signals may be conveyed in one or more frequency bands associated with the communications protocol.

Implementations in which AP 104 and STA 106 communicate according to an IEEE 802.11 protocol or standard are described herein as an example. Under an 802.11 protocol, the wireless data is organized into a series or flow of frames (e.g., media access control (MAC) frames) carried by the radio-frequency signals. The frames, which are sometimes also referred to as packets, may include management frames, control frames, data frames, beacon frames, association frames, authentication frames, acknowledgement (ACK) frames, block ACK frames, trigger frames, trigger response frames, and/or other types of frames. Each frame may include a frame header, body (e.g., after the header), and trailer (e.g., after the body). The header may include, for example, source address information identifying the transmitter of the frame, destination address information identifying the intended recipient of some or all of the frame, routing information, identifier information identifying one or more aspects of some or all of the frame (e.g., information identifying the type of frame), Association Identifier (AID) fields, control information, etc. The body may include, for example, a data payload (e.g., a payload of voice data, video data, web browsing data, application data, etc.). The trailer may include checking information that helps to verify the frame to the recipient. The checking information may include a frame check sequence (FCS) or cyclic redundancy check (CRC) field, as examples. If desired, the header, body, and/or trailer may include one or more message integrity check fields (e.g., hash values or the output of other cryptographic functions that take as an input different portions of the frame and that are used to verify the integrity of the frame when received by a recipient).

Under a bidirectional communications link between AP 104 and STA 106, frames are conveyed both from AP 104 to STA 106 and from STA 106 to AP 104. STA 106 may transmit one or more ACK frames or block ACK frames to AP 104 to acknowledge the successful receipt of one or more frames transmitted by AP 104. AP 104 may transmit one or more ACK frames or block ACK frames to STA 106 to acknowledge the successful receipt of one or more frames transmitted by AP STA 106.

Radio-frequency signals are transmitted in a downlink (DL) direction from AP 104 to STA 106. Radio-frequency signals transmitted in the DL direction are sometimes also referred to herein as DL signals. The DL signals may carry DL data (e.g., DL frames transmitted by AP 104 to STA 106). Radio-frequency signals are transmitted in an uplink (UL) direction from STA 106 to AP 104. Radio-frequency signals transmitted in the UL direction are sometimes also referred to herein as UL signals. The UL signals may carry UL data (e.g., UL frames transmitted by STA 106 to AP 104).

Wireless data conveyed between STA 106 and AP 104 may include quality-of-service (QoS) data and non-quality-of-service (nQoS) data. QoS data is more latency sensitive than nQoS data (e.g., may require transmission with lower latency than nQoS data to minimize or eliminate noticeable disruptions to user experience with STA 106). QoS data may include, for example, audio or video call data, streaming video game data, screen sharing data, etc. The communications protocol governing communications between STA 106 and AP 104 (e.g., an IEEE 802.11 protocol) may implement one or more mechanisms to prioritize QoS data over nQoS data, optimizing user experience with STA 106 (e.g., to minimize dropped calls, garbled audio, dropped packets, etc.). STA 106 may, if desired, transmit QoS characteristic information to AP 104 that identifies one or more characteristics of STA 106 associated with the transmission and/or reception of QoS data.

The communications protocol may implement a trigger-based UL transmission scheme. Under the trigger-based UL transmission scheme, AP 104 periodically transmits trigger frames to STA 106 that trigger the transmission of UL data by STA 106 (e.g., STA 106 transmits a UL frame to AP 104 in response to receipt of each trigger frame from AP 104). The transmission of trigger frames by AP 104 to STA 106 is sometimes also referred to herein as AP 104 triggering STA 106 or triggering UL transmission by STA 106.

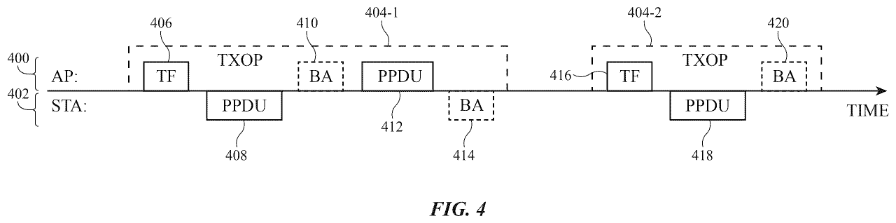

FIG. 4 is a timing diagram showing one example of how AP 104 and STA 106 may perform trigger-based communications under an IEEE 802.11 protocol. Row 400 of FIG. 4 illustrates an example of DL transmissions by AP 104 to STA 106. Row 402 of FIG. 4 illustrates an example of UL transmissions by STA 106 to AP 104.

AP 104 may transmit a trigger frame (TF) 406 during a first transmit opportunity (TXOP) 404-1. TF 406 may be a basic trigger frame or a multi-user (MU) request to send (RTS) TXOP sharing (TXS) trigger frame, as two examples. STA 106 may receive TF 406 and may transmit a UL frame 408 to AP 104 in response to receipt of TF 406 (e.g., TF 406 may trigger the transmission of UL frame 408 by STA 106). In the example of FIG. 4, UL frame 408 is a PPDU frame that contains a UL PPDU. UL frame 408 may be, for example, a PPDU that is a single user (SU) PPDU or a trigger based (TB) PPDU.

If desired, AP 104 may transmit an optional block acknowledgement (BA) frame 410 in response to receipt of UL frame 408. BA frame 410 may acknowledge, to STA 106, the receipt of UL frame 408 at AP 104 (e.g., to inform STA 106 that AP 104 has successfully received UL frame 408). If desired, AP 104 may then transmit a DL frame 412 (e.g., a PPDU frame that contains a DL PPDU). If desired, STA 106 may transmit an optional BA frame 414 in response to receipt of DL frame 412.

In the example of FIG. 4, AP 104 transmits an additional trigger frame (TF) 416 during a second TXOP 404-2 after first TXOP 404-1. During second TXOP 404-2, AP 104 may transmit an additional TF 416. TF 416 may be a basic trigger frame or an MU RTS TXS trigger frame, as two examples. STA 106 may receive TF 416 and may transmit another UL frame 418 to AP 104 in response to receipt of TF 416 (e.g., TF 416 may trigger the transmission of UL frame 418 by STA 106). In the example of FIG. 4, UL frame 418 is a PPDU frame that contains a UL PPDU. UL frame 418 may be, for example, a SU PPDU frame or a TB PPDU frame, as two examples. If desired, AP 104 may transmit an optional block acknowledgement (BA) frame 420 in response to receipt of UL frame 408. This process may continue as AP 104 triggers additional UL frame transmissions by STA 106 during subsequent TXOPs.

Some versions of the IEEE 802.11 protocol utilized by STA 106 and AP 104 may implement a Stream Classification Service (SCS) and QoS characteristic protocol, under which certain IP flows are characterized as QoS flows to be prioritized over nQoS flows and under which STA 106 may request that AP 104 trigger STA 106 based on a minimum/maximum service interval and a minimum data rate (among other parameters such as Delay Bound, etc.). If care is not taken, situations can arise in which AP 104 allocates excessive resources to STA 106 in its trigger frame(s) (e.g., an excessive resource unit (RU) size, an excessive trigger based (TB) physical protocol data unit (PPDU) duration, etc.) and/or in which AP 104 transmits trigger frames to STA 106 more frequently than needed by STA 106, despite STA 106 providing AP 104 with its QoS traffic characteristics in advance (e.g., while establishing an initial SCS agreement with AP 104). Either case can result in STA 106 transmitting excessive padding and/or null transmissions in its UL responses to the trigger frames. This is because STA 106 always transmits a UL frame in response to each trigger frame received from AP 104, even when STA 106 does not have UL data to transmit to STA 106. STA 106 fills portions of the triggered UL frame that are not utilized to convey UL data (because STA 106 has no corresponding UL data to transmit) with padding (e.g., a series of zero bits). The less UL data STA 106 has to transmit when triggered, the more padding STA 106 includes in the UL frame. When STA 106 has no UL data to transmit when triggered by AP 104, STA 106 transmits a null UL frame to AP 104 (e.g., a frame having 100% padding). Excessive padding in the UL frames transmitted by STA 106 represents inefficient wireless propagation medium utilization by STA 106 and wastes transmission resources by transmitting and receiving null data. This also represents wasted power consumption at STA 106 and/or AP 104, thereby limiting device battery life where applicable, because power is consumed to transmit and receive UL frames that carry little or no non-padding UL data.

To mitigate these issues and maximize medium utilization efficiency by STA 106 and AP 104, STA 106 may generate and transmit trigger frame feedback to AP 104. The trigger frame feedback may inform AP 104 of one or more characteristics of STA 106 associated with the reception of and/or response to one or more received trigger frames. AP 104 may utilize the trigger frame feedback to adjust the transmission of subsequent trigger frames in a manner that increases the medium utilization efficiency of AP 104 and STA 106 (e.g., by reducing the amount of padding needed in subsequently triggered UL frames transmitted by STA 106), that benefits the entire basic service set (BSS) associated with AP 104, and/or that minimizes wasted or needless power consumption at STA 106.

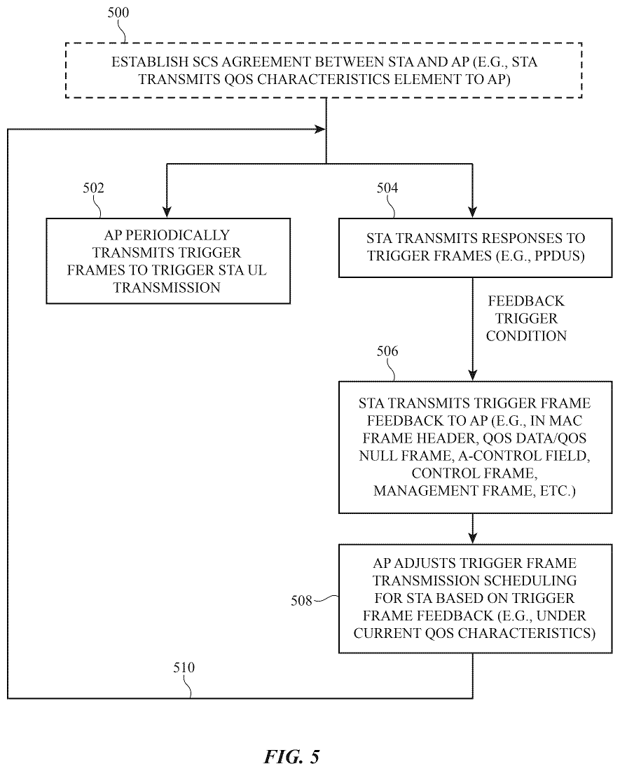

FIG. 5 is a flow chart showing one example of illustrative operations that may be involved in using STA 106 to transmit trigger frame feedback to AP 104 for use in adjusting subsequent trigger frames transmitted to STA 106.

At optional operation 500, AP 104 and STA 106 may establish an SCS agreement. This may involve STA 106 transmitting an SCS request frame and/or a QoS characteristic element to AP 104 and may establish a corresponding QoS session between AP 104 and STA 106. The QoS characteristic element may include information identifying one or more characteristics of STA 106 associated with the transmission and/or reception of QoS data (e.g., given the capabilities and/or resources of the wireless circuitry on STA 106). AP 104 may utilize these characteristics in triggering subsequent UL transmissions by STA 106 (e.g., the AP may transmit trigger frames in a manner that attempts to meet the characteristics while balancing traffic with other STAs in communication with the AP). Operation 500 may be omitted if desired (e.g., in implementations where STA 106 and AP 104 communicate using an 802.11 protocol that does not define or implement an SCS and QoS characteristic protocol or scheme). Processing may proceed to operations 502 and 504 in parallel (e.g., at least some of operation 502 may be performed concurrent and/or interleaved with at least some of operation 504).

At operation 502, AP 104 may periodically transmit trigger frames to STA 106 (e.g., TF 406 and TF 416 of FIG. 4). Each trigger frame may trigger a UL transmission by STA 106.

At operation 504, STA 106 may transmit a respective UL frame (sometimes also referred to herein as a response frame or a UL response frame) in response to receipt of each of the trigger frames transmitted by AP 104 (e.g., UL frames 408 and 418 of FIG. 4). In other words, the trigger frames transmitted by AP 104 may trigger the transmission of corresponding UL frames by STA 106. AP 104 may continue to perform operation 502 and STA 106 may continue to perform operation 504 as AP 104 continues to trigger the transmission of corresponding UL data by STA 106.

Processing may proceed to operation 506 if/when a feedback trigger condition occurs. The feedback trigger condition may be a drop in the wireless performance of STA 106 (e.g., one or more wireless performance metrics or key performance indicators (KPIs) measured or tracked by STA 106) by at least a threshold amount, the use of excessive padding in the UL frames transmitted by STA 106 (e.g., a percentage of padding that exceeds a threshold), excessive latency at STA 106, the passage of a predetermined time period, the failure of STA 106 to receive trigger frames for at least a predetermined time period, the receipt of trigger frames at STA 106 at more frequently than a maximum threshold frequency or less frequently than a minimum threshold frequency, a drop in UL and/or DL data rate at STA 106 by at least a predetermined amount, a user input received by STA 106, an application call by an application running on STA 106, and/or any other desired condition that may be addressed by the transmission of trigger frame feedback from STA 106 to AP 104. If the feedback trigger condition does not occur, AP 104 may continue to trigger UL transmissions by STA 106 without adjusting trigger frame scheduling.

At operation 506 (e.g., responsive to the feedback trigger condition), STA 106 may generate and transmit trigger frame feedback to AP 104. The trigger frame feedback (sometimes also referred to herein as trigger frame feedback information, feedback information, trigger feedback information, trigger feedback, or simply as feedback) may inform AP 104 of one or more characteristics of STA 106 associated with the reception of and/or UL response to one or more received trigger frames and/or that instructs or requests AP 104 to adjust one or more characteristics of subsequently transmitted trigger frames (e.g., in a manner that optimizes performance at STA 106 and/or mitigates the feedback trigger condition).

STA 106 may transmit the trigger frame feedback to AP 104 in any desired UL container or frame structure. As one example, STA 106 may transmit the trigger frame feedback in a MAC frame header of a SU PPDU frame, TB PPDU frame, management frame, control frame (e.g., a BA frame), QoS data frame, QoS null frame, or another type of UL frame transmitted to AP 104. The trigger frame feedback may be included in an existing or newly defined aggregated control (A-control) identifier (ID) field of the MAC header, as one example. As another example, STA 106 may transmit the trigger frame feedback in any desired field of an existing control frame (e.g., a BA frame, multi-STA BA frame, a response frame to an Initial Control Frame (ICF) in a frame exchange sequence, etc.) or a specifically or newly defined control frame (e.g., a control frame defined for the purpose of transmitting the trigger frame feedback). As another example, STA 106 may transmit the trigger frame feedback in any desired field of an existing, specifically, or newly defined management frame (e.g., a management frame for transmission of non-frequency reports). In general, STA 106 may transmit the trigger frame feedback in any desired container structure in any desired field of any desired UL frame type.

At operation 508, AP 104 may receive the trigger frame feedback transmitted by STA 106. AP 104 may adjust scheduling for the transmission of one or more subsequent (future) trigger frames based on the trigger frame feedback received from STA 106 (e.g., given the current QoS characteristics pursuant to the SCS agreement).

As one example, AP 104 may adjust the scheduling of subsequent trigger frames by transmitting the subsequent trigger frames more or less frequently than previous trigger frames. As used herein, the frequency of trigger frame transmission refers to how often AP 104 transmits trigger frames to STA 106 (e.g., every 5 ms, every 7 ms, every 10 ms, etc.). AP 104 may, for example, trigger STA 106 less frequently when triggering has been too high compared to one trigger per minimum service interval (minServiceInterval) and/or may trigger STA 106 more frequently for calibration purposes and/or to accommodate a temporary traffic increase.

As another example, AP 104 may adjust the scheduling of subsequent trigger frames by adjusting the resource allocation included within and/or identified by the subsequent trigger frames. For example, AP 104 may adjust the data rate, RU allocation size, UL length, modulation coding scheme (MCS), and/or number of spatial streams (NSS) in the subsequent trigger frames. A reference for these changes may be other parameters such as MCS, etc., in the last resource allocation or a fixed MCS, etc., as defined in the communication protocol specification. In some cases, STA 106 may request AP 104 to increase the resources allocated per trigger frame (e.g., when the allocated resources are small and not sufficient to transmit the buffered data units at all). AP 104 may, if desired, adjust both how frequently the AP transmits the subsequent trigger frames and the resource allocation in the subsequent trigger frames in response to receipt of the trigger frame feedback.

Processing may subsequently loop back to operations 502 and 504 via path 510. AP 104 may periodically transmit subsequent trigger frames according to the scheduling adjustment performed at operation 508 (e.g., during the next iteration of operation 502). STA 106 may transmit responses to the subsequent trigger frames (e.g., during the next iteration of operation 504). The adjustment to trigger frame scheduling performed at operation 508 may serve to optimize the efficiency with which STA 106 utilizes its communications resources, power, and the wireless propagation medium in transmitting UL frames to AP 104 responsive to the trigger frames.

If desired, AP 104 may transmit information to or may otherwise signal STA 106 to inform STA 106 that AP 104 is capable of receiving trigger frame feedback and/or that AP 104 is currently configured to receive trigger frame feedback. Such signaling may be performed prior to, after, at, between, and/or concurrent with one or more of operations 500-504, for example. If desired, STA 106 may transmit information to or may otherwise signal AP 104 to inform AP 104 that STA 106 is capable of transmitting trigger frame feedback to AP 104 and/or that STA 106 is currently configured to transmit trigger frame feedback. Such signaling may be performed prior to, after, at, between, and/or concurrent with one or more of operations 500-504, for example. This signaling may, for example, be expressed as a capability (e.g., using one or more bits in a capability field of a corresponding container that identifies the capabilities of AP 104 and/or STA 106).

Additionally or alternatively, AP 104 may solicit trigger frame feedback from STA 106 (e.g., prior to, after, at, between, and/or concurrent with one or more of operations 500-504). As one example, AP 104 may include, in a given trigger frame transmitted to STA 106 (sometimes also referred to as a feedback-soliciting trigger frame), information (e.g., one or more bits) that serve to request or solicit the transmission of trigger frame feedback by STA 106 (e.g., that specifically solicit the transmission of trigger frame feedback rather than other types of UL data). STA 106 may then transmit trigger frame feedback responsive to receipt of such a feedback-soliciting trigger frame (e.g., a given trigger frame may trigger the transmission of trigger frame feedback by STA 106). Alternatively, AP 104 may transmit other frames (e.g., non-trigger frames) that solicit the transmission of trigger frame feedback by STA 106. Alternatively, STA 106 may transmit the trigger frame feedback (at operation 506) without any explicit indication or solicitation of the trigger frame feedback by AP 104.

If desired, STA 106 may transmit trigger frame feedback for one or more links of a corresponding SCS agreement. In other cases, STA 106 may transmit the trigger frame feedback for a specific link. This may, for example, be indicated in a field a Link Identifier (LinkID) or a LinkID bitmap as part of the feedback. The indicated link(s) may be the same as the current link or may be different from the current link where the feedback is sent.

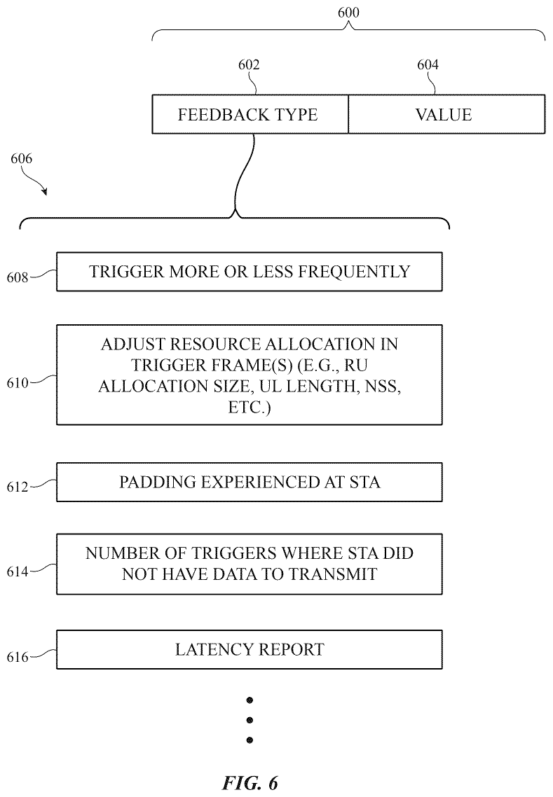

FIG. 6 is a diagram of illustrative trigger frame feedback that STA 106 may generate and transmit to AP 104 (e.g., while processing operation 506 of FIG. 5). As shown in FIG. 6, STA 106 may generate and transmit trigger frame feedback 600 (sometimes also referred to herein as trigger frame feedback information 600, feedback information 600, trigger feedback information 600, trigger feedback 600, trigger frame feedback signal 600, trigger frame feedback container 600, or simply as feedback 600). Trigger frame feedback 600 may include a feedback type field 602 and a corresponding value field 604.

Feedback type field 602 and value field 604 may be consecutive, continuous, or contiguous fields of the overarching UL frame structure or may be non-consecutive, non-continuous, or non-contiguous fields of the overarching UL frame structure. Feedback type field 602 may label, specify, or otherwise identify the type of trigger frame feedback being transmitted by STA 106. Value field 604 may include or identify a value associated with a preferred change associated with the type of feedback identified by feedback type field 602 for use by AP 104 in adjusting the scheduling of subsequent trigger frame transmission.

Portion 606 of FIG. 6 illustrates different potential types of trigger frame feedback that may be included in or identified by feedback type field 602. For example, as shown by block 608, feedback type field 602 may include information identifying that STA 106 is requesting that AP 104 trigger STA 106 more or less frequently than for previous trigger frames. In this example, the corresponding value field 604 may identify a particular frequency with which AP 104 is to transmit subsequent trigger frames or may identify a particular change (e.g., a percent change) in the frequency with which AP 104 is to transmit subsequent trigger frames (relative to the current or previous frequency with which AP 104 transmits trigger frames).

Consider an example in which AP 104 transmits trigger frames to STA 106 every 5 ms but where STA 106 only has enough UL data to support UL transmission every 7 ms. In this example, the excessive frequency with which AP 104 transmits trigger frames can cause STA 106 to include excessive padding in the UL frames transmitted in response to the trigger frames, representing an inefficient utilization of the propagation medium and resources of STA 106. Feedback type field 602 may include information that instructs or identifies to AP 104 that STA 106 is requesting a decrease in the frequency with which AP 104 transmits trigger frames. Value field 604 may identify an amount by which the AP should decrease the frequency of trigger frame transmission (e.g., by X ms⁻¹ or by X %) or may identify a particular frequency with which AP 104 is to transmit trigger frames (e.g., once every 7 ms) to meet the current or expected future UL data transmission needs of STA 106 (e.g., without causing STA 106 to transmit UL frames with excessive padding in response to the trigger frames).

As shown by block 610, feedback type field 602 may include information identifying that STA 106 is requesting that AP 104 adjust the resource allocation in subsequent trigger frames. Feedback type field 602 and/or value field 604 may identify particular resources that are to be provided with an adjusted resource allocation (e.g., RU allocation size, UL length, NSS, and/or other resources that contribute to the UL data rate of STA 106). In this example, value field 604 may identify a particular resource allocation (e.g., a preferred RU allocation size, a preferred UL length, a preferred NSS, etc.) for subsequent trigger frames to be transmitted by AP 104. Alternatively, value field 604 may identify an amount by which the AP is to adjust the current or previous resource allocation of its transmitted trigger frames (e.g., a particular change or percent change to RU allocation size, UL length, NSS, etc., relative to the current or previous allocation). The change in resource allocation may be one that allows STA 106 to meet its current or expected future UL data transmission needs (e.g., without causing STA 106 to transmit UL frames with excessive padding in response to the trigger frames). If desired, STA 106 may indicate, in trigger frame feedback 600, a preferred data rate for itself, which may be larger or smaller than the data rate allocated to STA 106 (e.g., in a previously received trigger frame). In this case, AP 104 may adjust the data rate allocation for STA 106 based on such feedback (e.g., while processing operation 508 of FIG. 5).

As shown by block 612, feedback type field 602 may include information identifying that STA 106 is informing AP 104 of the amount of padding experienced at STA 106 (e.g., a UL padding report). In this example, the corresponding value field 604 may identify a particular amount of padding used by STA 106 in a particular triggered UL frame, in multiple triggered UL frames (e.g., value field 604 may include a detailed padding report), or over a particular time period (e.g., the average amount of padding used by STA 106 over the time period). The amount of padding may be reported as a padding percent (e.g., a percent of some or all of the UL frame that is occupied by padding) or in other formats. By informing AP 104 of the amount of padding experienced, AP 104 may adjust the scheduling of subsequent trigger frames in a manner that reduces the amount of padding experienced at STA 106 (e.g., when the amount of padding experienced exceeds a threshold). This may cause STA 106 to transmit subsequently triggered UL frames without excessive padding, maximizing resource utilization efficiency at STA 106. If desired, the amount of padding experienced may be identified by a detailed padding report including statistics per RU allocation or other parameters (e.g., carried as part of a management frame).

As shown by block 614, feedback type field 602 may include information identifying that STA 106 is informing AP 104 of the number of trigger frames received by STA 106, where STA 106 did not have sufficient UL data to transmit to AP 104. In this example, the corresponding value field 604 may identify particular trigger frames where STA 106 did not have UL data to transmit in the responsive UL frame or may identify a number of trigger frames over a predetermined time period where STA 106 did not have UL data to transmit in the responsive UL frame. By informing AP 104 of the amount of trigger frames where STA 106 did not have UL data to transmit in response, AP 104 may adjust the scheduling of subsequent trigger frames in a manner that reduces the amount of padding experienced at STA 106 (e.g., when the number of triggers without UL data exceeds a threshold). This may cause STA 106 to transmit subsequently triggered UL frames without excessive padding, maximizing resource utilization efficiency at STA 106.

As shown by block 616, feedback type field 602 may include information identifying that STA 106 is informing AP 104 of an amount of latency experienced at STA 106 (e.g., in a latency report). In this example, the corresponding value field 604 may identify particular latency experienced at STA 106, a low latency buffer size of STA 106 (e.g., per traffic identifier (TID) or SCSIS) to indicate the traffic that corresponds to the triggered flow, etc. By informing AP 104 of the latency of STA 106, AP 104 may adjust the scheduling of subsequent trigger frames in a manner that reduces the amount of padding experienced at STA 106. This may cause STA 106 to transmit subsequently triggered UL frames without excessive padding, maximizing resource utilization efficiency at STA 106. If desired, the latency report may include information identifying the observed latency relative to an expected latency per SCS agreement. This may include real time feedback, may be solicited or unsolicited, and/or may, if desired, be computed per time window or per number of PPDUs for a particular latency percentile.

In general, trigger frame feedback 600 may include any desired combination of one or more of blocks 608-616 and/or other feedback types in one or more feedback type fields 602, each having a corresponding value field 604 or sharing a given value field 604 (e.g., value field 604 may combine values for multiple different feedback types if desired). AP 104 may adjust the frequency of triggering and/or the allocated resources of triggering (e.g., while processing operation 508 of FIG. 5) based on trigger frame feedback 600. In a home use scenario, for example, it may be casier for AP 104 to change its triggering resource allocation than its triggering frequency due to the low number of STAs deployed in a home environment. If desired, AP 104 may group STAs with similar clients together for triggering purposes. If desired, STA 106 may indicate or identify a target padding level for its UL resources (e.g., 20%) to AP 104 in an SCS request frame and/or another frame transmitted to AP 104 at the beginning of the corresponding QoS session (e.g., while processing operation 500 of FIG. 5). In this case, AP 104 may meet the target padding level when scheduling a basic trigger frame or an MU RTS TXS trigger frame for STA 106.

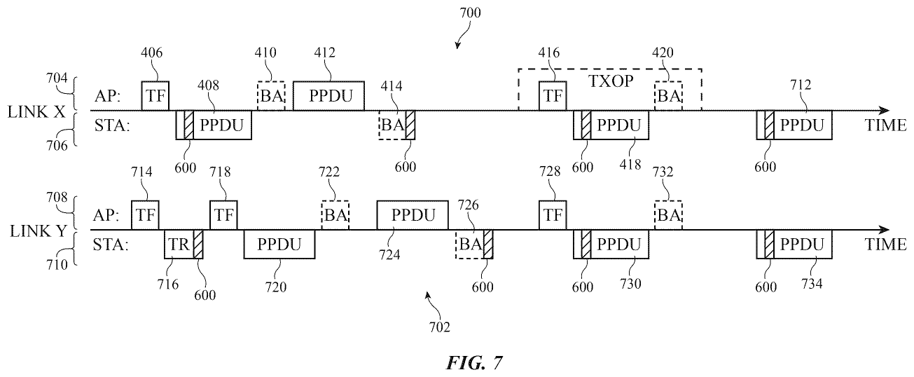

In general, STA 106 may transmit trigger frame feedback 600 to AP 104 in any desired UL container or frame structure. FIG. 7 is a timing diagram showing potential containers for trigger frame feedback 600. Portion 700 of FIG. 7 shows communication between AP 104 and STA 106 for a first link X that includes the same DL transmissions and trigger-based UL transmissions as shown in the example of FIG. 4. Portion 702 of FIG. 7 shows communication between AP 104 and STA 106 for a second link Y that includes a different example of UL and DL transmissions. Portions 700 and 702 may be concurrent or may be entirely non-overlapping in time. Link Y may be between the same STA 106 and AP 104 as link X or may between AP 104 and a different STA 106 than link X.

As shown in the example of portion 700, STA 106 may include trigger frame feedback 600 in UL frame 408 (e.g., in a MAC header field or another field of an SU PPDU or TB PPDU frame) and/or in BA frame 414 (e.g., in a MAC header field or another field of the BA frame) to cause AP 104 to adjust the scheduling of subsequent trigger frames (e.g., TF 416 for the next TXOP). If desired, STA 106 may include trigger frame feedback 600 in UL frame 418 (e.g., in a MAC header field or another field of an SU PPDU or TB PPDU frame) and/or a subsequent UL frame 712 (e.g., in a MAC header field or another field of an SU PPDU or TB PPDU frame) to cause AP 104 to adjust the scheduling of even later trigger frames.

As shown in the example of portion 702, in some situations, STA 106 may transmit a trigger response (TR) 716 in response to a received TF 714. TF 714 and/or TF 406 may be initial control frames (ICFs), for example. As other examples, TF 714 may be a basic trigger frame, a buffer status report poll (BSRP) trigger frame, an MU RTS trigger frame, an MU RTS TXS trigger frame, or a variant of one or more of these types of frames. TR 716 may be, for example, a control frame response (e.g., a control frame response dedicated to transmitted trigger frame feedback or another control frame). If desired, STA 106 may include trigger frame feedback 600 in TR 716 (e.g., in a MAC header field or another field of TR 716). The trigger frame feedback 600 in TR 716 may cause AP 104 to adjust scheduling (e.g., timing/frequency and/or resource allocation) of the next TF 718. AP 104 may transmit TF 718 according to the adjusted scheduling. STA 106 may transmit a UL frame 720 in response to TF 718. AP 104 may transmit an optional BA frame 722 in response to UL frame 720.

If desired, AP 104 may transmit a DL frame 724. STA 106 may optionally transmit a BA frame 726 in response to DL frame 724. If desired, STA 106 may include trigger frame feedback 600 in BA frame 726 (e.g., in a MAC header field or another field of BA frame 726). Unlike TR frame 716, which is a triggered frame (e.g., a triggered control frame) transmitted by STA 106 in response to a corresponding trigger frame (e.g., TF 714), BA frame 726 is transmitted in response to a DL data frame (e.g., a PPDU frame) and is not a triggered frame that is transmitted in response to a DL trigger frame.

The trigger frame feedback 600 in BA 726 may cause AP 104 to adjust scheduling (e.g., timing/frequency and/or resource allocation) of the next TF 728. AP 104 may transmit TF 728 according to the adjusted scheduling. STA 106 may transmit a UL frame 730 in response to TF 718 (e.g., an SU PPDU or a TB PPDU). AP 104 may transmit an optional BA frame 732 in response to UL frame 730. If desired, STA 106 may include trigger frame feedback 600 in UL frame 730 (e.g., in a MAC header field or another field of an SU PPDU or TB PPDU frame) and/or a subsequent UL frame 734 (e.g., in a MAC header field or another field of an SU PPDU or TB PPDU frame) to cause AP 104 to adjust the scheduling of even later trigger frames. These examples are illustrative and non-limiting.

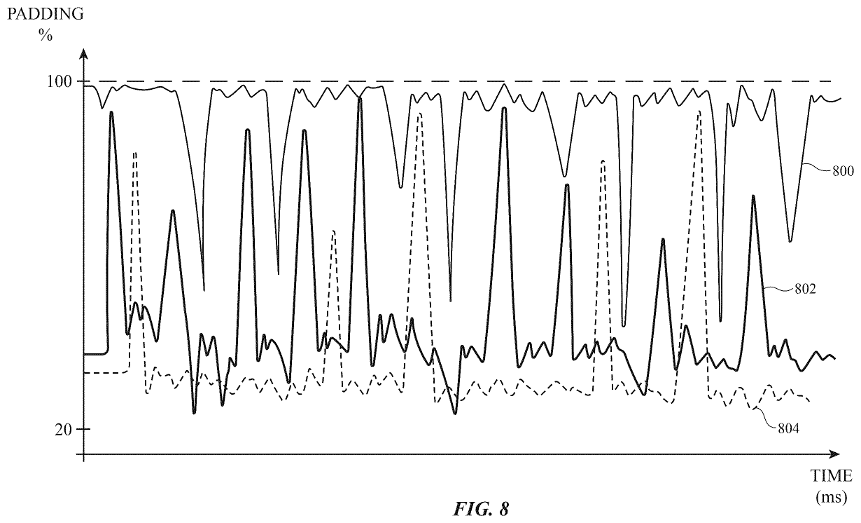

FIG. 8 is a plot of padding percentage as a function of time, illustrating how transmitting trigger frame feedback 600 may optimize the communication efficiency of STA 106 while transmitting a particular data stream (e.g., a stream of video call data). Curve 800 plots the padding percentage utilized by STA 106 without transmitting trigger frame feedback to AP 104. As shown by curve 800, STA 106 may utilize an excessive amount of padding without the trigger frame feedback mechanisms described herein (e.g., due to poor resource allocation in the trigger frames and/or transmission of trigger frames more frequently than required for the UL data that STA 106 has to transmit to AP 104). This represents poor communications and resource consumption efficiency at STA 106 and AP 104.

Curve 802 plots the padding percentage utilized by STA 106 when AP 104 adjusts the frequency with which AP 104 transmits trigger frames to STA 106 (e.g., while processing operation 508 of FIG. 5). As shown by curve 802, STA 106 may utilize substantially less padding than without the trigger frame feedback mechanisms described herein (e.g., due to AP 104 transmitting trigger frames to STA 106 at a lower frequency that meets the UL data transmission needs of STA 106). This represents a substantial improvement in communications and resource consumption efficiency at STA 106 and AP 104.

Dashed curve 804 plots the padding percentage utilized by STA 106 when AP 104 adjusts both the frequency and the resource allocation of its transmitted trigger frames (e.g., while processing operation 508 of FIG. 5). As shown by curve 800, STA 106 may utilize even less padding than when AP 104 only adjusts the frequency of trigger frame transmission. This represents even more improvement in communications and resource consumption efficiency at STA 106 and AP 104. This example is illustrative and, in practice, curves 800-804 may have other shapes.

If desired STA 106 may identify or include additional parameters in trigger frame feedback 600 (FIG. 6). As one example, trigger frame feedback 600 may include or identify one or more preferred links for STA 106. AP 104 may adjust subsequent trigger frame scheduling in favor of the preferred link(s). In the case of multi-link operation, STA 106 may prefer to operate on a particular link during a given SCS agreement. For example, if AP 104 allocates 80% of the time on the preferred link, STA 106 may exhibit a lower packet error rate, MCS, etc., preventing unnecessary re-transmissions and saving airtime.

On the other hand, there may be some cases during an SCS session where the triggering AP is insufficient. For example, there may be a sudden surge in traffic during a video call. This may be addressed by STA 106 requesting that AP 104 trigger more frequently or allocate more resources to STA 106. Alternatively, if STA 106 is operating in a mode that requires an ICF such as when STA 106 is an enhanced multi-link single-radio (EMLSR) client, there may be cases where STA 106 can indicate to AP 104 that it prefers BSRP/BSR as an ICF, allowing the AP to adjust its allocation based on the buffer status report (BSR) to account for the sudden surge in traffic. If desired, the STA may indicate the required allocation for a transient period of time to reduce complexity on the AP scheduler.

As another example, trigger frame feedback 600 may include or identify a preferred access mechanism. In some cases, AP 104 may not be able to trigger STA 106. As such, a STA 106 that is operating in an multi-user enhanced distributed channel access (MU EDCA) mode may prefer to leave the MU EDCA mode to contend for channel access without waiting for the MU EDCA Timer to expire. This can be allowed through signaling or specification rules for a limited time up to the transmission of packets (e.g., of a particular TID, Access Category, or SCS identification (SCSID)) to meet the delay bound. If desired, there may be limitations on the number of such attempts within a time interval (e.g., the Beacon Interval). Such parameters may, if desired, be defined in the SCS agreement (e.g., at operation 500 of FIG. 5).

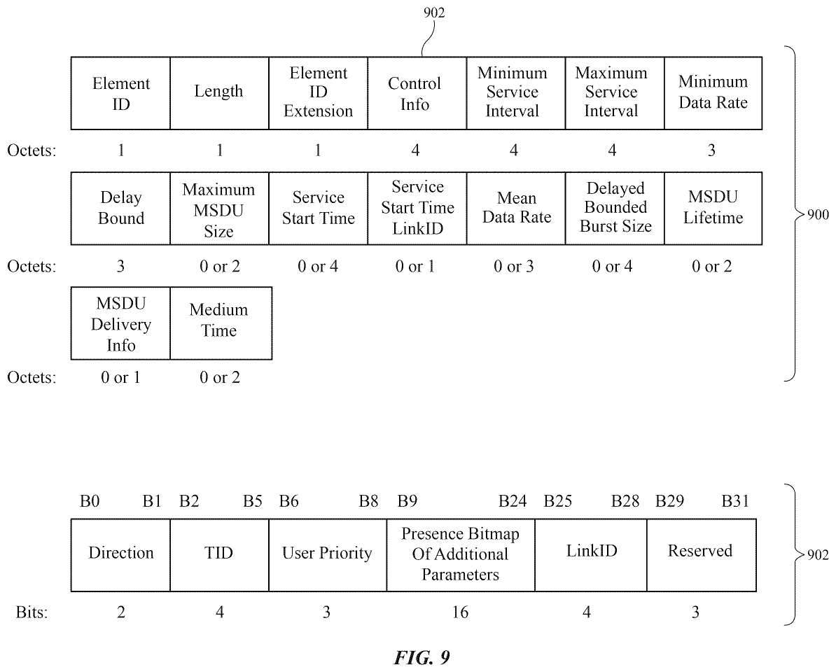

FIG. 9 is a diagram showing one example of a QoS characteristic element 900 that may be transmitted by STA 106 to AP 104 (e.g., at operation 500 of FIG. 5). As shown in FIG. 9, QoS characteristic element 900 may have different fields of different lengths (e.g., an Element ID field, followed by a Length field, followed by an Element ID Extension field, followed by a Control Information field 902, followed by a Minimum Service Interval field, followed by a Maximum Service Interval field, followed by a Minimum Data Rate field, followed by a Delay Bound field, followed by a Maximum MAC service data unit (MSDU) size field, followed by a Service Start Time field, followed by a Service Start Time LinkID field, followed by a Mean Data Rate field, followed by a Delayed Bounded Burst Size field, followed by an MSDU lifetime field, followed by an MSDU Delivery Information field, followed by a Medium Time field).

Control information field 902 may include, for example, a Direction field followed by a TID field, followed by a User Priority field, followed by a Presence Bitmap of Additional Parameters field, followed by a LinkID field, followed by a Reserved field. The fields of QoS characteristic element 900 may identify various QOS characteristics of STA 106 for use by AP 104 in establishing an SCS agreement with STA 106 and for use by AP 104 in scheduling subsequent communications with STA 106. The example of FIG. 9 is illustrative and, if desired, QoS characteristic element 900 may have other fields and the fields of QoS characteristic element 900 may be arranged in other orders. The structure of QoS characteristic element 900 may be specified by the communication protocol governing communications between STA 106 and AP 104. STA 106 may transmit QoS characteristic element 900 in an SCS request frame or in a separate frame if desired.

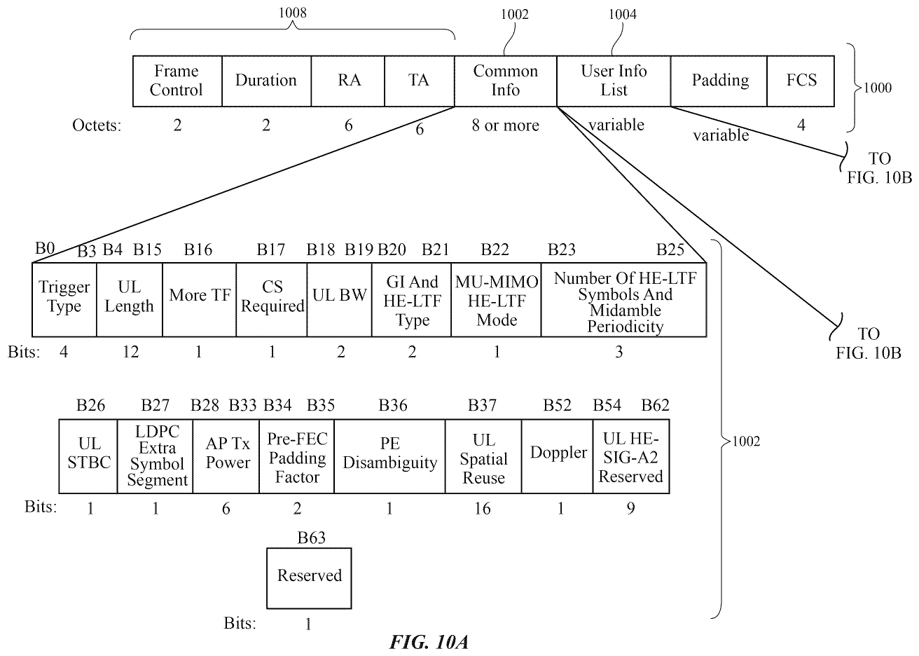

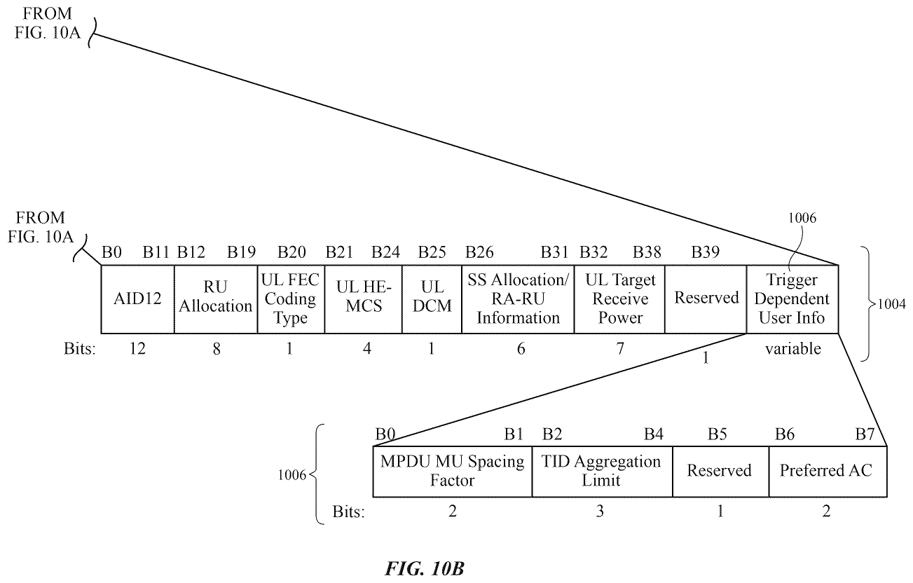

FIGS. 10A and 10B include a diagram showing one example of a basic trigger frame 1000 that may be transmitted by AP 104 to STA 106 (e.g., any of trigger frames 404, 416, 714, 718, and/or 728 of FIG. 7 as transmitted at operation 502 of FIG. 5). The structure of basic trigger frame 1000 may be specified by the communication protocol governing communications between STA 106 and AP 104.

As shown in FIGS. 10A and 10B, basic trigger frame 100 may have different fields of different lengths (e.g., a MAC header 1008 that includes a Frame Control field followed by a Duration field, a Receiver Address (RA) field, and a Transmitter Address (TA) field, followed by a Common Information field 1002, followed by a User Information List field 1004, followed by a Padding field, followed by an FCS field).

Common information field 1002 may include, for example, a Trigger Type field followed by a UL Length field, followed by a More TF field, followed by a CS Required field, followed by a UL Bandwidth (BW) field, followed by a GI and HE-LTF Type field, followed by a Multi-user Multiple-Input and Multiple-Output (MU-MIMO) HE-LTF Mode field, followed by a Number of HE-LTF Symbols and Midamble Periodicity field, followed by a UL Space Time Block Coding (STBC) field, followed by a Low Density Parity Check (LDPC) Extra Symbol Segment field, followed by an AP TX Power field, followed by a Pre-FEC Padding Factor field, followed by a PE Disambiguity field, followed by a UL Spatial Reuse field, followed by a Doppler field, followed by a UL HE-SIG-A2 Reserved field, followed by a Reserved field.

User Information List field 1004 may include, for example, an association identifier (AID) field such as an AID12 field followed by an RU Allocation field, followed by a UL Forward Error Correction (FEC) Coding Type field, followed by a UL HE-MCS field, followed by a UL Dual Carrier Modulation (DCM) field, followed by a SS Allocation RA-RU Information field, followed by a UL Target Receive Power field, followed by a Reserved field, followed by a Trigger Dependent User Information field 1006. Trigger Dependent User Information field 1006 may include, for example, an MPDU MU Spacing Factor field followed by a TID Aggregation Limit field, followed by a Reserved field, followed by a Preferred AC field. The example of FIGS. 10A and 10B is illustrative and, if desired, basic trigger frame 1000 may have other fields and the fields of basic trigger frame 1000 may be arranged in other orders.

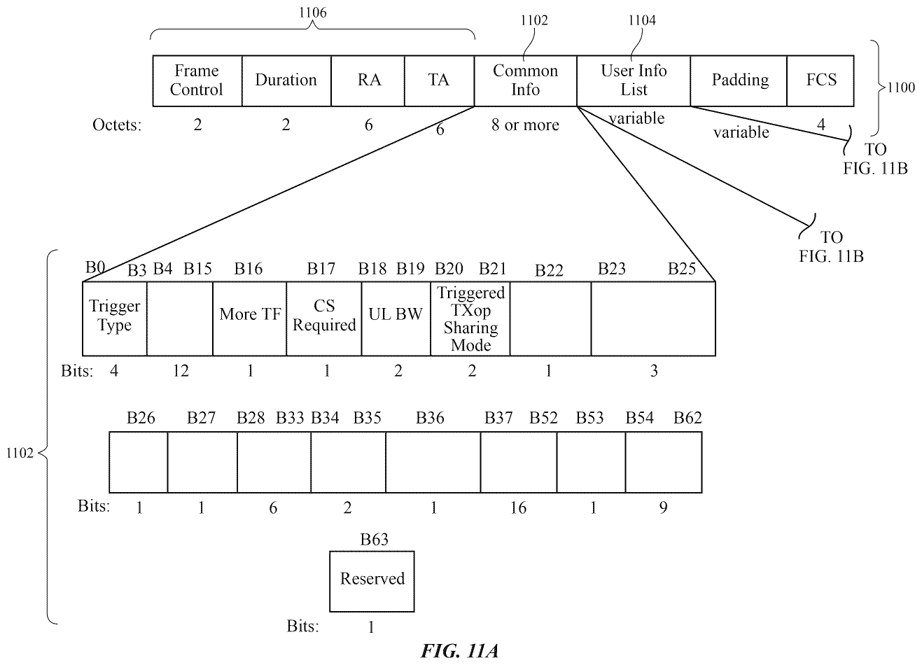

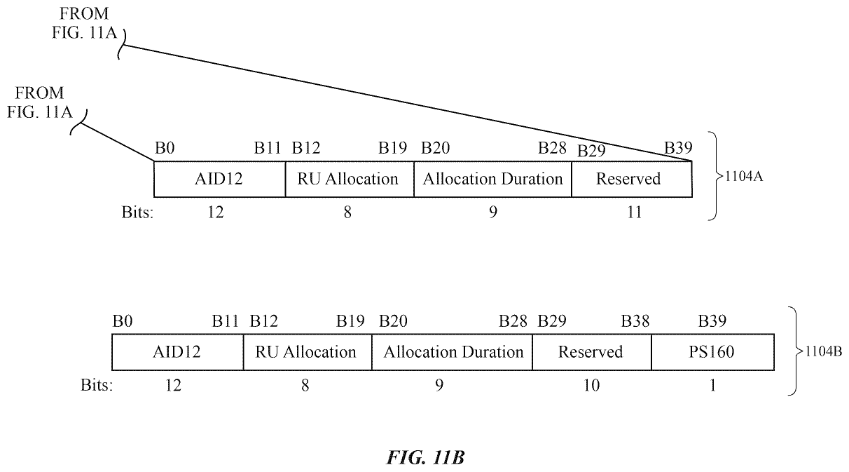

FIGS. 11A and 11B include a diagram showing one example of an MU RTS TXS trigger frame 1100 that may be transmitted by AP 104 to STA 106 (e.g., any of trigger frames 404, 416, 714, 718, and/or 728 of FIG. 7 as transmitted at operation 502 of FIG. 5). The structure of MU RTS TXS trigger frame 1100 may be specified by the communication protocol governing communications between STA 106 and AP 104.

As shown in FIGS. 11A and 11B, MU RTS TXS trigger frame 1100 may have different fields of different lengths (e.g., a MAC header 1106 that includes a Frame Control field followed by a Duration field, a RA field, and a TA field, followed by a Common Information field 1102, followed by a User Information List field 1104, followed by a padding field, followed by an FCS

### FIELD

Common information field 1102 may include, for example, a Trigger Type field followed by other fields such as a More TF field, a CS Required Field, a UL BW field, a Triggered TXOP Sharing Mode field, and a Reserved Field. In a first implementation, User Information List field 1104 may include User Information List field 1104A (e.g., an HE variant User Information Field format) which includes, for example, an AID12 field followed by an RU Allocation field, followed by an Allocation Duration field, followed by a Reserved Field. In a second implementation User Information List field 1104 may include User Information List field 1104B (e.g., an EHT variant User Information Field format) which includes, for example, an AID12 field followed by an RU Allocation field, followed by an Allocation Duration field, followed by a Reserved field, followed by a PS160 Field). The example of FIGS. 11A and 11B is illustrative and, if desired, MU RTS TXS trigger frame 1100 may have other fields and the fields of MU RTS TXS trigger frame 1100 may be arranged in other orders.

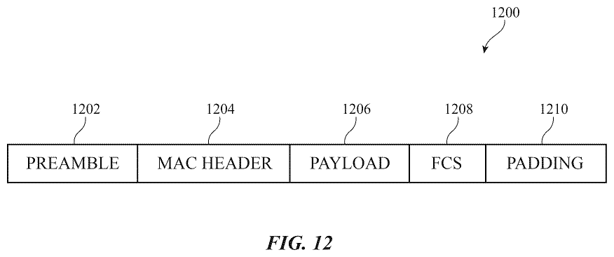

FIG. 12 is a diagram showing one example of a UL frame 1200 that may be transmitted by STA 106 to AP 104 (e.g., any of UL frames 408, 418, 712, 720, 730, or 734, or any of BA frames 414 or 726, or TR frame 716 of FIG. 7, as transmitted by STA 106 during operation 504 of FIG. 5). The structure of UL frame 1200 may be specified by the communication protocol governing communications between STA 106 and AP 104.

As shown in FIG. 12, UL frame 1200 may include a preamble 1202 (e.g., a physical layer preamble), followed by MAC header 1204, followed by data payload 1206, followed by FCS field 1208, followed by padding field 1210. STA 106 may, if desired, include trigger frame feedback 600 (FIG. 6) in MAC header 1204 and/or in another field of UL frame 1200. The example of FIG. 12 is illustrative and, if desired, UL frame 1200 may have other fields and the fields of UL frame 1200 may be arranged in other orders.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” The term “when” also implies at least some concurrency (e.g., event A occurring “when” event B occurs means that at least some of event A is concurrent with at least some of event B).

STAs 106 and APs 102/104 (FIG. 1) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-23 may be performed by the components of a STA and/or AP using software, firmware, and/or hardware (e.g., dedicated circuitry or hardware). Software code for performing these operations may be stored on non-transitory computer readable storage media (e.g., tangible computer readable storage media) stored on one or more of the components of the STA and/or AP. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the STA and/or AP. The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth in the example section below. For example, circuitry associated with an electronic device, authentication server, one or more processors, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a station (STA) to communicate with an access point (AP) according to a communications protocol that implements trigger-based uplink (UL) transmission, the method comprising: receiving, using one or more antennas, downlink (DL) signals transmitted by the AP according to the communications protocol; transmitting, using the one or more antennas, trigger frame feedback to the AP, the trigger frame feedback being based at least in part on the DL signals; receiving, using the one or more antennas, trigger frames that are transmitted by the AP based on the trigger frame feedback; and transmitting, using the one or more antennas, UL frames responsive to the trigger frames transmitted by the AP.

Example 2 includes the method of example 1 or some other example or combination of examples herein, wherein the trigger frame feedback comprises a request for the AP to adjust how frequently the AP triggers UL transmission by the STA.

Example 3 includes the method of examples 1 or 2 or some other example or combination of examples herein, wherein the request identifies a frequency with which the AP is to transmit the trigger frames to the STA.

Example 4 includes the method of any one or examples 1-3 or some other example or combination of examples herein, wherein the request identifies an increase or a decrease to a frequency with which the AP is to transmit the trigger frames to the STA, the increase or decrease being relative to a frequency with which the AP triggered previous UL transmissions by the STA.

Example 5 includes the method of any one or examples 1˜4 or some other example or combination of examples herein, wherein the trigger frame feedback comprises a request for the AP to adjust a resource allocation of at least one of the trigger frames relative to a resource allocation of a previous trigger frame transmitted by the AP.

Example 6 includes the method of any one or examples 1-5 or some other example or combination of examples herein, wherein the request for the AP to adjust the resource allocation comprises a request for the AP to adjust a resource unit (RU) allocation size, an UL length, or a number of spatial streams (NSS) of the at least one of the trigger frames.

Example 7 includes the method of any one or examples 1-6 or some other example or combination of examples herein, wherein the UL frames comprise a single user physical protocol data unit (SU PPDU) or a trigger-based physical protocol data unit (TB PPDU).

Example 8 includes the method of any one or examples 1-7 or some other example or combination of examples herein, wherein transmitting the trigger frame feedback comprises transmitting the trigger frame feedback within a media access control (MAC) header.

Example 9 includes the method of any one or examples 1-8 or some other example or combination of examples herein, wherein the MAC header is a MAC header of a UL physical protocol data unit (PPDU) frame.

Example 10 includes the method of any one or examples 1-9 or some other example or combination of examples herein, wherein the trigger frame feedback is included in an aggregated control (A-control) field of the MAC header.

Example 11 includes the method of any one or examples 1-10 or some other example or combination of examples herein, wherein transmitting the trigger frame feedback comprises transmitting the trigger frame feedback in a UL control frame.

Example 12 includes the method of any one or examples 1-11 or some other example or combination of examples herein, wherein transmitting the trigger frame feedback comprises transmitting the trigger frame feedback in a UL management frame.

Example 13 includes the method of any one or examples 1-12 or some other example or combination of examples herein, wherein transmitting the trigger frame feedback comprises transmitting the trigger frame feedback in block acknowledgement (BA) frame responsive to a DL frame in the DL signals.

Example 14 includes the method of any one or examples 1-13 or some other example or combination of examples herein, wherein transmitting the trigger frame feedback comprises transmitting the trigger frame feedback in a trigger response frame.

Example 15 includes the method of any one or examples 1-14 or some other example or combination of examples herein, wherein the trigger frame feedback comprises information identifying an amount of padding included in one or more UL transmissions performed by the STA in response to the DL signals.

Example 16 includes the method of any one or examples 1-15 or some other example or combination of examples herein, wherein the trigger frame feedback comprises information identifying a number of trigger frames received by the STA or a latency of the STA.

Example 17 includes an electronic device configured to communicate with an access point (AP) according to a communications protocol that implements trigger-based uplink (UL) transmission, the electronic device comprising: one or more antennas configured to receive trigger frames transmitted by the AP; and a transmitter communicatively coupled to the one or more antennas, the transmitter being configured to transmit, using the one or more antennas, a request to the AP to adjust a schedule with which the AP transmits the trigger frames, and transmit, using the one or more antennas, UL frames to the AP responsive to the trigger frames transmitted by the AP.

Example 18 includes the electronic device of example 17 or some other example or combination of examples herein, wherein the request comprises a request to the AP to adjust how often the AP transmits the trigger frames.

Example 19 includes the electronic device of examples 17 or 18 or some other example or combination of examples herein, wherein the request comprises a request to the AP to adjust a resource allocation of the trigger frames transmitted by the AP.

Example 20 includes the electronic device of any one or examples 17-19 or some other example or combination of examples herein, wherein the request comprises a feedback type field and a corresponding value field.

Example 21 includes the electronic device of any one or examples 17-20 or some other example or combination of examples herein, wherein the feedback type field and the value field are included in a media access control (MAC) header of a physical protocol data unit (PPDU) frame transmitted, by the transmitter and the one or more antennas, to the AP.

Example 22 includes the electronic device of any one or examples 17-21 or some other example or combination of examples herein, wherein the feedback type field and the value field are included in a block acknowledgment (BA) frame transmitted, by the transmitter and the one or more antennas, to the AP.

Example 23 includes the electronic device of any one or examples 17-22 or some other example or combination of examples herein, wherein the feedback type field and the value field are included in a trigger frame response transmitted, by the transmitter and the one or more antennas, to the AP.

Example 24 includes a method of operating an access point (AP) to communicate with a station (STA) according to a communications protocol that implements trigger-based uplink (UL) transmission, the method comprising: periodically transmitting trigger frames to the STA, wherein the trigger frames trigger UL transmissions by the STA; receiving trigger frame feedback from the STA; adjusting transmission of the trigger frames based on the trigger frame feedback; and receiving, from the STA, UL frames transmitted by the STA in response to the trigger frames.

Example 25 includes the method of example 24 or some other example or combination of examples herein, wherein adjusting transmission of the trigger frames comprises increasing or decreasing how often the AP transmits the trigger frames.

Example 26 includes the method of examples 24 or 25 or some other example or combination of examples herein, wherein adjusting transmission of the trigger frames comprises adjusting a resource allocation of the trigger frames.

Example 27 includes the method of any one of examples 24-26 or some other example or combination of examples herein, wherein the trigger frames comprise a basic trigger frame, a buffer status report poll (BSRP) trigger frame, a multi-user (MU) request to send (RTS) trigger frame, or a MU RTS triggered transmit opportunity sharing (TXS) trigger frame.

Example 28 may include an apparatus comprising means to perform one or more elements of a method described in or related to any of examples 1-27 or any combination thereof, or any other method or process described herein.

Example 29 may include one or more non-transitory computer-readable media comprising instructions to cause an electronic device, upon execution of the instructions by one or more processors of the electronic device, to perform one or more elements of a method described in or related to any of examples 1-27 or any combination thereof, or any other method or process described herein.

Example 30 may include an apparatus comprising logic, modules, or circuitry to perform one or more elements of a method described in or related to any of examples 1-27 or any combination thereof, or any other method or process described herein.

Example 31 may include a method, technique, or process as described in or related to any of examples 1-27 or any combination thereof, or portions or parts thereof.

Example 32 may include an apparatus comprising: one or more processors and one or more non-transitory computer-readable storage media comprising instructions that, when executed by the one or more processors, cause the one or more processors to perform the method, techniques, or process as described in or related to any of examples 1-27, or any combination thereof, or portions thereof.

Example 33 may include a signal as described in or related to any of examples 1-27, or any combination thereof, or portions or parts thereof.

Example 34 may include a datagram, information element, packet, frame, segment, PDU, or message as described in or related to any of examples 1-27, or any combination thereof, or portions or parts thereof, or otherwise described in the present disclosure.

Example 35 may include a signal encoded with data as described in or related to any of examples 1-26, or any combination thereof, or portions or parts thereof, or otherwise described in the present disclosure.

Example 36 may include a signal encoded with a datagram, IE, packet, frame, segment, PDU, or message as described in or related to any of examples 1-26, or any combination thereof, or portions or parts thereof, or otherwise described in the present disclosure.

Example 37 may include an electromagnetic signal carrying computer-readable instructions, wherein execution of the computer-readable instructions by one or more processors is to cause the one or more processors to perform the method, techniques, or process as described in or related to any of examples 1-27, or any combination thereof, or portions thereof.

Example 38 may include a computer program comprising instructions, wherein execution of the program by a processing element is to cause the processing element to carry out the method, techniques, or process as described in or related to any of examples 1-27, or any combination thereof, or portions thereof.

Example 39 may include a signal in a wireless network as shown and described herein.

Example 40 may include a method of communicating in a wireless network as shown and described herein.

Example 41 may include a system for providing wireless communication as shown and described herein.

Example 42 may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

What is claimed is:

1. A method of operating a station (STA) to communicate with an access point (AP) according to a communications protocol that implements trigger-based uplink (UL) transmission, the method comprising:
receiving, using one or more antennas, downlink (DL) signals transmitted by the AP according to the communications protocol;
transmitting, using the one or more antennas, trigger frame feedback to the AP, the trigger frame feedback being based at least in part on the DL signals;
receiving, using the one or more antennas, trigger frames that are transmitted by the AP based on the trigger frame feedback; and
transmitting, using the one or more antennas, UL frames responsive to the trigger frames transmitted by the AP.

2. The method of claim 1, wherein the trigger frame feedback comprises a request for the AP to adjust how frequently the AP triggers UL transmission by the STA.

3. The method of claim 2, wherein the request identifies a frequency with which the AP is to transmit the trigger frames to the STA.

4. The method of claim 2, wherein the request identifies an increase or a decrease to a frequency with which the AP is to transmit the trigger frames to the STA, the increase or decrease being relative to a frequency with which the AP triggered previous UL transmissions by the STA.

5. The method of claim 1, wherein the trigger frame feedback comprises a request for the AP to adjust a resource allocation of at least one of the trigger frames relative to a resource allocation of a previous trigger frame transmitted by the AP, and wherein the request for the AP to adjust the resource allocation comprises a request for the AP to adjust a resource unit (RU) allocation size, an UL length, or a number of spatial streams (NSS) of the at least one of the trigger frames.

6. The method of claim 1, wherein the UL frames comprise a single user physical protocol data unit (SU PPDU) or a trigger-based physical protocol data unit (TB PPDU).

7. The method of claim 1, wherein transmitting the trigger frame feedback comprises transmitting the trigger frame feedback within a media access control (MAC) header of a UL physical protocol data unit (PPDU) frame.

8. The method of claim 1, wherein the trigger frame feedback is included in an aggregated control (A-control) field of a media access control (MAC) header.

9. The method of claim 1, wherein transmitting the trigger frame feedback comprises transmitting the trigger frame feedback in a UL control frame or in a UL management frame.

10. The method of claim 1, wherein transmitting the trigger frame feedback comprises transmitting the trigger frame feedback in a block acknowledgement (BA) frame responsive to a DL frame in the DL signals or in a trigger response frame.

11. The method of claim 1, wherein the trigger frame feedback comprises information identifying an amount of padding included in one or more UL transmissions performed by the STA in response to the DL signals and wherein the trigger frame feedback comprises information identifying a number of trigger frames received by the STA or a latency of the STA.

12. An electronic device configured to communicate with an access point (AP) according to a communications protocol that implements trigger-based uplink (UL) transmission, the electronic device comprising:
one or more antennas configured to receive trigger frames transmitted by the AP; and
a transmitter communicatively coupled to the one or more antennas, the transmitter being configured to
transmit, using the one or more antennas, a request to the AP to adjust a schedule with which the AP transmits the trigger frames, and
transmit, using the one or more antennas, UL frames to the AP responsive to the trigger frames transmitted by the AP.

13. The electronic device of claim 12, wherein the request comprises a request to the AP to:
adjust how often the AP transmits the trigger frames, or
adjust a resource allocation of the trigger frames transmitted by the AP.

14. The electronic device of claim 12, wherein the request comprises a feedback type field and a corresponding value field, and wherein the feedback type field and the value field are included in a media access control (MAC) header of a physical protocol data unit (PPDU) frame transmitted, by the transmitter and the one or more antennas, to the AP.

15. The electronic device of claim 12, wherein the request comprises a feedback type field and a corresponding value field, and wherein the feedback type field and the value field are included in a block acknowledgment (BA) frame transmitted, by the transmitter and the one or more antennas, to the AP.

16. The electronic device of claim 15, wherein the feedback type field and the value field are included in a trigger frame response transmitted, by the transmitter and the one or more antennas, to the AP.

17. A method of operating an access point (AP) to communicate with a station (STA) according to a communications protocol that implements trigger-based uplink (UL) transmission, the method comprising:
periodically transmitting trigger frames to the STA, wherein the trigger frames trigger UL transmissions by the STA;
receiving trigger frame feedback from the STA;
adjusting transmission of the trigger frames based on the trigger frame feedback; and
receiving, from the STA, UL frames transmitted by the STA in response to the trigger frames.

18. The method of claim 17, wherein adjusting transmission of the trigger frames comprises increasing or decreasing how often the AP transmits the trigger frames.

19. The method of claim 17, wherein adjusting transmission of the trigger frames comprises adjusting a resource allocation of the trigger frames.

20. The method of claim 17, wherein the trigger frames comprise a basic trigger frame, a buffer status report poll (BSRP) trigger frame, a multi-user (MU) request to send (RTS) trigger frame, or a MU RTS triggered transmit opportunity sharing (TXS) trigger frame.
